(19) United States
(12) Patent Application Publication
(10) Pub. No.: US 2007/0203263 A1
(43) Pub. Date: Aug. 30, 2007

(54) Process For The Continuous Preparation Of Silicone Emulsions

(75) Inventors: Robert Schroeck, Altotting (DE); Otto Schneider, Burghausen (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 10/599,869

(22) PCT Filed: Apr. 14, 2005
(86) PCT No.: PCT/EP05/03960

§ 371 Date: Oct. 12, 2006

(30) Foreign Application Priority Data
Apr. 15, 2004 (DE) 10 2004 018 283.3

(51) Int. Cl. B01F 3/08

(52) U.S. Cl. 523/322

(57) ABSTRACT

Aqueous silicone emulsions are prepared by emulsifying silicone, emulsifier, and water in a first high shear mixer, and introducing the viscous phase thereby obtained obtained, optionally with further components, into a second high shear mixture. A set point for temperature and pressure after each mixer is established, and the measured temperatures and pressures are used in a feedback loop to adjust process parameters such that the set points are maintained.

The invention relates to a process for the continuous preparation of aqueous silicone emulsions, the process being regulated by means of the pressures and temperatures, which are measured directly after the mixers.

Silicone emulsions are commercially available as milky white macroemulsions in the form of w/o or o/w emulsions and as opaque to transparent microemulsions. They are mixtures of at least one water-insoluble silicone oil, resin or elastomer, at least one emulsifier and water. For the preparation of the emulsion, these components are mixed with one another and dispersed with the use of, for example, heat and cold, mechanical shearing, which can be produced by means of narrow gaps in mixers.

The silicone component of the emulsion can be prepared in an upstream reaction outside the emulsification unit and then dispersed in the emulsification unit. Alternatively, the silicone component of the emulsion can be produced in the emulsification unit itself (in situ preparation). Characteristic of the in situ preparation is that a chemical reaction takes place shortly before, during or shortly after the preparation of the emulsion.

Typical reactions for the in situ preparation or polymerization of the silicone component are all reactions used in silicone chemistry which lead to chain extension or equilibration, such as, for example, polymerization, condensation or polyaddition reactions.

In the preparation of silicone emulsions using shearing, typically the silicone is first mixed with at least one emulsifier and a small amount of water and exposed to high shearing, for example in a rotor-stator mixer having narrow gaps. Typically, a w/o emulsion having a very high viscosity, which is referred to as a so-called “stiff phase”, forms. The viscosity of this stiff phase is very dependent on the shearing. This stiff phase is then slowly diluted with water up to the inversion point. At the inversion point, the w/o emulsion becomes an o/w emulsion. The formation of this stiff phase and the method of dilution with water to the desired final concentration of the emulsion determine the quality of the emulsion. Quality of the emulsion is to be understood as meaning in particular the particle size, the distribution of the particle size, the storage stability and the tolerance of the emulsion to heating and/or cooling, vibrations, change of pH, change of salt content, etc.

The abovementioned preparation of silicone emulsions by means of shearing can be effected batchwise or continuously.

U.S. Pat. No. 5,806,975 describes an apparatus and a method for emulsifying highly viscous silicones in an extruder-like apparatus.

U.S. Pat. No. 5,563,189 claims the two-stage continuous emulsion preparation, an emulsion having a high solids content being prepared in the first stage and then being diluted with additional water to the desired final concentration in a second shearing apparatus.

EP 874 017 claims a method for the preparation of silicone-in-water emulsions, at least one polysiloxane, a further siloxane which reacts with the first-mentioned one by means of chain extension and a metal catalyst for this purpose and furthermore an emulsifier and water being continuously mixed and emulsified.

WO 02/42360 describes the continuous preparation of emulsions by means of one or more shearing mixers, the siloxane, the emulsifier and the water being fed to the mixer through a pipe for the formation of a stiff phase and the pressure at the inlet of the mixer being kept constant at 20%.

The invention relates to a process for the continuous preparation of aqueous emulsions which comprise organosilicon compound (A), emulsifier (B) and water (C), in which in each case a part of the components organosilicon compound (A), emulsifier (B) and water (C) is fed continuously to a first high-shear mixer in which a highly viscous phase of a silicone emulsion is formed,

and, in a second high-shear mixer, further components which are selected from organosilicon compound (A), emulsifier (B) and water (C) are admixed,

the process being regulated by means of the pressures and temperatures, which are measured directly after the mixers.

It was found that the pressure and the temperature after the high-shear mixers are determinative for the quality of the emulsions of organosilicon compounds, and the quality of the emulsions prepared can be substantially improved by the regulation. The regulation leads in the case of microemulsions to clearer products having small particle sizes. In the case of macroemulsions, substantially smaller particle sizes and improved storage and dilution stabilities are achieved. With the temperature control, control of the particle sizes is possible. This effect is supported by the pressure regulation.

The pressure and the temperature are regulated to a target value for the respective products. The regulation of the pressure is preferably effected by pressure maintenance after the second high-shear mixer and by the speed or geometry of the high-shear mixers. The high-shear mixers have different deliveries depending on the speed, which influences the pressure in the downstream pipe. The regulation of the temperature is preferably effected by the temperature of the raw materials and the speed of the mixers. The higher the speed of the mixers, the more energy in the form of mixing energy and heat is supplied, and vice versa. Suitable high-shear mixers are, for example, rotor-stator mixers, high-speed stirrers/dissolvers, colloid mills, microchannels, membranes, high-pressure homogenizers and jet nozzles, in particular rotor-stator mixers.

There are different values for the pressures and temperatures after the mixers, depending on the product and its viscosity. The pressure are preferably from 1 to 10 bar. The temperatures are preferably from 5° C. to 100° C. Preferably, the pressure and the temperature are highest in or behind the first high-shear mixer, which produces the highly viscous phase.

In the first high-shear mixer, preferably at least 50, preferably at least 70, % by weight of the organosilicon compound (A) are admixed. In the first high-shear mixer, preferably at least 60, preferably at least 80, % by weight of the emulsifier (B) are admixed.

In the process, organosilicon compound (A), emulsifier (B) and water (C) are fed to the first high-shear mixer, for example by means of continuously delivering pumps, such as centrifugal pumps, shear pumps, rotary piston pumps or rotating spindle pumps. For some emulsions, it may be advantageous to feed a mixture of emulsifier (B) and water (C) to the first high-shear mixer itself. For this purpose, a further high-shear mixer can be arranged before the first high-shear mixer. Furthermore, further mixers, preferably one or two mixers, can dilute and completely compound the emulsion after the second high-shear mixer.

In addition to organosilicon compound (A), emulsifier (B) and water (C), further additives (Z) can be fed to the first or second high-shear mixer or incorporated in further mixers. Preferably, additives (Z) are incorporated in the second high-shear mixer or in further mixers. It is also possible to feed mixtures of (A), (B) and (C) and other additives (Z), which are pre-mixed, for example, in a storage tank, to the first high-shear mixer.

For certain products, it is advantageous to install a further high-shear mixer after the second high-shear mixer in the product stream in order to achieve greater shearing of the emulsions. It is also possible to use the mixer for the preparation of a pre-emulsion, solution or mixture of, for example, incompletely water-soluble emulsifiers or thickeners with water.

In the process, all silanes and organopolysiloxanes can be used as organosilicon compound (A), as well as mixtures, solutions or dispersions thereof. Examples are linear organopolysiloxanes and silicone resins. Silicone resins are understood as meaning products which not only contain mono- and difunctional silicon units but also have tri- and tetrafunctional silicon units.

The emulsions prepared according to the invention have a content of at least 1% to 98%, preferably from 5% to 90%, particularly preferably from 9 to 80%, of organosilicon compound (A). The particle sizes vary from 1 nm to 1000 μm, preferably from 5 nm to 300 μm, particularly preferably from 10 nm to 200 μm. The pH may vary from 1 to 14, preferably from 2 to 10, particularly preferably from 3 to 9.

Organosilicon compound (A) is preferably liquid at 25° C. and preferably has viscosities of from 0.5 to 500 000 mPa·s, in particular from 2 to 80 000 mPa·s.

Examples of organosilicon compounds are organosilicon compounds which contain units of the general formula I
AₐR_{b}SiX_{c}O_{[4-(a+b+c)]/2} (I)
in which
R is a hydrogen atom or a monovalent, divalent or trivalent hydrocarbon radial having 1 to 200 carbon atoms, which may be substituted by halogen, amine, ammonium, mercapto, acrylate or maleimide groups,
X is a chlorine atom, a radical of the formula —O⁻, it being possible for protons and/or organic and/or inorganic ionic substances to be present to compensate the charges, a radical of the general formula —OR¹ or a radical of the general formula II
   —(R²)ₕ[OCH₂CH₂]ₑ[OC₃H₆]_{f}[OC₄H)₄]_{g}OR³ (II)
   in which
R¹ is a hydrogen atom or a hydrocarbon radical having 1 to 200 carbon atoms, which may be interrupted by one or more identical or different heteroatoms which are selected from O, S, N and P.
R² is a divalent hydrocarbon radical having 1 to 200 carbon atoms, which may be interrupted by one or more groups of the formulae —C(O)—, —C(O)O—, —C(O)NR¹, —NR¹—, —N⁺HR¹—, —O—, —S— and/or substituted by F, Cl or Br,
R³ may have a meaning of R¹ or is a radical of the formulae —C(O)R¹ or —Si(R¹)₃,
A is a radical of the general formula IV
   —R⁴(B)_{z} (IV)
   in which
R⁴ is a divalent, trivalent or tetravalent hydrocarbon radical having 1 to 200 carbon atoms per radical, which may be interrupted by one or more groups of the formulae —C(O)—, —C(O)O—, —C(O)NR⁵, —NR⁵—, —N⁺HR⁵—, —N⁺R⁵R⁵—, —O—, —S—, —(HO)P(O)— or —(NaO)P(O)— and/or substituted by F, Cl or Br, in which
R⁵ is a hydrogen atom or a hydrocarbon radical having 1 to 200 carbon atoms per radical, which may be interrupted by one or more groups of the formulae —C(O)—, —C(O)O—, —C(O)NR⁵—, —NR⁵—, —N⁺HR⁵—, —N⁺R⁵R⁵—, —O— or —S— and/or substituted by F, Cl or Br,
B may have a meaning of R⁵ or is a radical which is selected from —COO⁻, —SO₃, —OPO₃H_{y}^{[2-y]}—, —N⁺R⁵R⁵R⁵—, —P⁺R⁵R⁵R⁵, —NR⁵R⁵, —OH, —SH, F, Cl, Br, —C(O)H, —COOH, —SO₃H, —C₆H₄—OH and —CₘF₂ₘ₊₁, 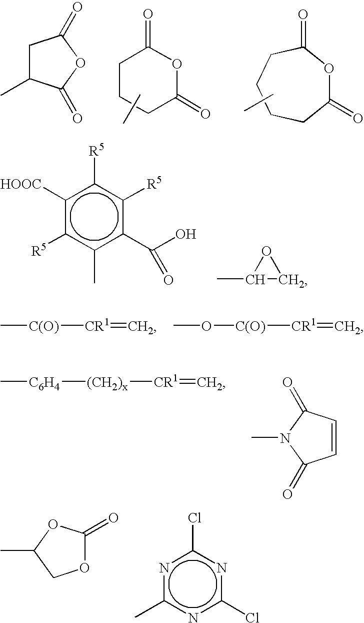
x is an integer of 1-20,
y has the values 0 or 1,
z has the values 1, 2 or 3, depending on the valency of R⁴,
h has the values 0 or 1,
m is an integer of 1-20,
a, b and c each have the values 0, 1, 2, 3 or 4 and the sum a+b+c is less than or equal to 4 and
e, f and g are each an integer of 0-200, with the proviso that the sum e+f+g is >1.

To compensate the charges of the radicals A, R and X, protons and/or organic or inorganic ionic substances can optionally be present, such as, for example, alkali metal, alkaline earth metal or ammonium ions, halide, sulfate, phosphate, carboxylate, sulfonate or phosphonate ions. Furthermore, the organosilicon compounds may optionally contain units of the general formulae (V) and (VI) 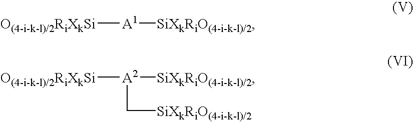
in which
A² is a trivalent hydrocarbon radical having 1 to 200 carbon atoms, which may be interrupted by radicals of the formulae —C(O)—, —C(O)O—, —C(O)NR⁵, —NR⁵—, —N⁺HR⁵—, —N⁺R⁵R⁵—, —O—, —S—, —N— or —N⁺R⁵— and/or substituted by F, Cl or Br,
A¹ is a divalent radical R²,
i and k each have the values 0, 1, 2 or 3, with the proviso that i+k<3 and
R and X have the abovementioned meanings.

The abovementioned hydrocarbon radicals R, R¹, R², R³, R⁴, R⁵, A¹ and A² may be saturated, unsaturated, linear, cyclic, aromatic or non-aromatic.

Examples of hydrocarbon radicals R are alkyl radicals, such as the methyl, ethyl, n-propyl, isopropyl, 1-n-butyl, 2-n-butyl, isobutyl, tert-butyl, n-pentyl, isopentyl, neopentyl or tert-pentyl radical; hexyl radicals, such as the n-hexyl radical; heptyl radicals, such as the n-heptyl radical; octyl radicals, such as the n-octyl radical, and isooctyl radicals such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl or cycloheptyl radical and methylcyclohexyl radicals; aryl radicals, such as the phenyl, naphthyl, anthryl and phenanthryl radical; alkaryl radicals, such as o-, m- and p-tolyl radicals; xylyl radicals and ethylphenyl radicals; and aralkyl radicals, such as the benzyl radical and the α- and the β-phenylethyl radical.

The hydrogen atom and the methyl, ethyl, octyl and phenyl radical are preferred, and the hydrogen atom or the methyl and ethyl radical are particularly preferred.

Examples of halogenated radicals R are haloalkyl radicals, such as the 3,3,3-trifluoro-n-propyl radical, the 2,2,2,2′,2′,2′-hexafluoroisopropyl radical, the heptafluoroisopropyl radical, and haloaryl radicals, such as the o-, m- and p-chlorophenyl radical.

Examples of radical R¹ are the examples stated for alkyl radicals R, and the methoxyethyl and the ethoxyethyl radical, radical R¹ preferably being alkyl radicals having 1 to 50 carbon atoms, which may be interrupted by oxygen atoms, particularly preferably the methyl and the ethyl radical.

Examples of organic or inorganic substances for compensating the charges for X═—O⁻ are, alkali metal and alkaline earth metal ions, ammonium and phosphonium ions, and monovalent, divalent or trivalent metal ions, preferably alkali metal ions, particularly preferably Na⁺ and K⁺.

Examples of radicals X are the methoxy or ethoxy radical and of the general formula (II), such as —(CH₂)₃—(OCH₂CH₂)₃—OCH₃, —(CH₂)₃—(OCH₂CH₂)₆—OCH₃, —(CH₂)₃—(OCH₂CH₂)₃₅—OCH₃, —(CH₂)₃—(OCH(CH₃)CH₂)₃—OCH₃, —(CH₂)₃—(OCH(CH₃)CH₂)₆—OCH₃, —(CH₂)₃—(OCH(CH₃)CH₂)₃₅—OCH₃, —(CH₂)₃—(OCH₂CH₂)₃—(OCH(CH₃)CH₂)₃—OCH₃, —(CH₂)₃—(OCH₂CH₂)₆—OCH(CH₃)CH₂)₆—OCH₃, —(CH₂)₃—(OCH₂CH₂)₃—(OCH(CH₃)CH₂)₃₅—OCH₃, —(CH₂)₃—(OCH₂CH₂)₃—OSi(CH₃)₃, —(CH₂)₃—(OCH₂CH₂)₆—OSi(CH₃)₃, —(CH₂)₃—(OCH₂CH₂)₃₅—OSi(CH₃)₃, —(CH₂)₃—(OCH₂CH₂)₃—OC(O)CH₃, —(CH₂)₃—(OCH₂CH₂)₆—OC(O)CH₃, —(CH₂)₃—(OCH₂CH₂)₃₅—OC(O)CH₃, —(OCH₂CH₂)₃—OH, —(OCH₂CH₂)₆—OH, —(OCH₂CH₂)₃₅—OH, —(OCH(CH₃)CH₂)₃—OH, —(OCH(CH₃)CH₂)₆—OH, —(OCH(CH₃)CH₂)₃₅—OH, —(OCH₂CH₂)₃—(OCH(CH₃)CH₂)₃—OH, —(OCH₂CH₂)₆—(OCH(CH₃)CH₂)₆—OH, —(OCH₂CH₂)₃—(OCH(CH₃)CH₂)₃₅—OH, —(OCH₂CH₂)₁₈—(O(CH₂)₄)₁₈—OH, —(OCH₂CH₂)₃—OCH₃, —(OCH₂CH₂)₆—OCH₃, —(OCH₂CH₂)₃₅—OCH₃, —(OCH(CH₃)CH₂)₃—OCH₃, —(OCH(CH₃)CH₂)₆—OCH₃, —(OCH(CH₃)CH₂)₃₅—OCH₃, —(OCH₂CH₂)₃—(OCH(CH₃)CH₂)₃—OCH₃, —(OCH₂ (CH₂)₆—(OCH(CH₃)CH₂)₆—OCH₃, —(OCH₂CH₂)₃—(OCH(CH₃)CH₂)₃₅—OCH₃, —(OCH₂CH₂)₃—OSi(CH₃)₃, —(OCH₂CH₂)₆—OSi(CH₃)₃, —(OCH₂CH₂)₃₅—OSi(CH₃)₃, —(OCH₂CH₂)₃—OC(O)CH₃, —(OCH₂CH₂)₆—OC(O)CH₃, —(OCH₂CH₂)₃₅—OC(O)CH₃, —(OCH₂CH₂)₃—OH, —(OCH₂CH₂)₆—OH, —(OCH₂CH₂)₃₅—O, —(OCH(CH₃)CH₂)₃—OH, —(OCH(CH₃)CH₂)₆—OH, —(OCH(CH₃)CH₂)₃₅—OH, —(OCH₂CH₂)₆—(OCH(CH₃)CH₂)₃—OH, —(OCH₂CH₂)₆—(OCH(CH₃)CH₂)₆—OH, —(OCH₂CH₂)₃₅—(OCH(CH₃)CH₂)₃₅—OH and —(OCH₂CH₂)₁₈—(O(CH₂)₄)₁₈—OH.

Examples of radicals R² are linear or branched, substituted or unsubstituted hydrocarbon radicals having preferably 2 to 10 carbon atoms, saturated or unsaturated alkylene radicals being preferred and the ethylene or the propylene radical being particularly preferred.

Examples of radicals R³ are the examples stated for alkyl radical or aryl radical R, and radicals of the formula —C(O)R¹ or —Si(R¹)₃, the methyl, ethyl, propyl and butyl and trialkylsilyl and —C(O)-alkyl radical being preferred and the methyl, butyl, —C(O)—CH₃ and the trimethylsilyl radical being particularly preferred.

Examples of R⁴ are radicals of the formulae
—(CH₂)₃—
—(CH₂)₃—O—CH₂—
—(CH₂)₃—O—(CH₂—CH₂O)ₙ—
—(CH₂)₃—O—CH₂—CH(OH)—CH₂—
—(CH₂)₃—NH—(CH₂)₂—
—(CH₂)₃—NH—C(O)—
—(CH₂)₃—NH— (CH₂)₂—C(O)—O—
—(CH₂)₃—NH—(CH₂)₂—C(O)—O—(CH₂)₂—
—(CH₂)₃—NH— (CH₂)₂—NH—C(O)—CH═CH—
—(CH₂)₃—NH—C(O)—CH═CH—
—(CH₂)₃—C₆H₄—

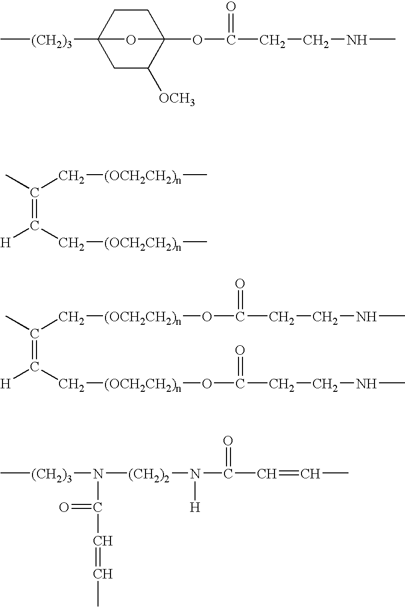

Preferred radicals R⁴ are those of the formulae
—(CH₂)₃—
—(CH₂)₃—NH—(CH₂)₂—
—(CH₂)₃—O—CH₂—CH(OH)—CH₂— 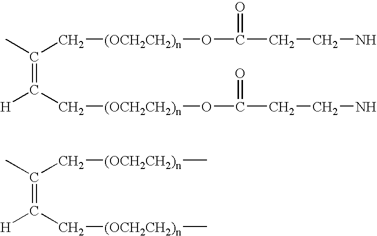
   R⁴ is particularly preferably —(CH₂)₃— and —(CH₂)₃—NH—(CH₂)₂—.

Examples of R⁵ are the alkyl and aryl radicals mentioned above in the case of R and radicals of the formulae —C(O)—CH₃ —C(CH₂CH₂O)₃—CH₃, —(CH₂CH₂O)₆—CH₃, —(CH₂CH₂O)₃₅—CH₃, —(CH(CH₃)CH₂O)₃—CH₃, —(CH(CH₃)CH₂O)₆—CH₃, —(CH(CH₃)CH₂O)₃₅—CH₃, —(CH₂CH₂O)₃—(CH(CH₃)CH₂O)₃—CH₃, —(CH₂CH₂O)₅—(CH₂—CH(CH₃)O)₅—CH₃, —(CH₂CH₂O)₁₀—(CH₂—CH(CH₃)O)₁₀—CH₃, —(CH₂CH₂O)₃—Si(CH₃)₃, —(CH₂CH₂O)₆—Si (CH₃)₃, —(CH₂CH₂O)₃₅—Si (CH₃)₃, —(CH₂CH₂O)₅—(CH₂—CH(CH₃)O)₅—Si (CH₃)₃, —(CH₂CH₂O)₁₀—(CH₂—CH(CH₃)O)₁₀—Si(CH₃)₃, —(CH₂CH₂O)₃—C(O)CH₃, —(CH₂CH₂O)₆—C(O)CH₃, —(CH₂CH₂O)₃₅—C(O)CH₃, —(CH₂CH₂O)₅—(CH₂—CH(CH₃)O)₅—C(O)CH₃, —(CH₂CH₂O)₁₀—(CH₂—CH(CH₃)O)₁₀—C(O)CH₃, —(CH₂CH₂O)₃—H, —(CH₂CH₂O)₆—H, —(CH₂CH₂O)₃₅—H, —(CH(CH₃)CH₂O)₃—H, —(CH(CH₃)CH₂O)₆—H, —(CH(CH₃)CH₂O)₃₅—H, —(CH₂CH₂O)₃—(CH(CH₃)CH₂O)₃—H, —(CH₂CH₂O)₅—(CH₂—CH(CH₃)O)₅—H, —(CH₂CH₂O)₁₀—(CH₂—CH(CH₃)O)₁₀—H and —(CH₂CH₂O)₁₈—((CH₂)₄O)₁₈—H.

The hydrogen atom and the examples stated for R are preferred, and the hydrogen atom and alkyl radicals are particularly preferred.

Examples of radicals B are —COONa, —SO₃Na, —COOH, —SH and in particular —OH, —NH₂, —NH—CH₃, —NH—(C₆H₁₁) and —N—(CH₂(CH₂—CH═CH₂)₂, —NH₂, —NH—CH₃ and —NH(C₆H₁₁) being particularly preferred.

Examples of A¹ are linear or branched, divalent alkyl radicals having preferably 2 to 20 carbon atoms, or radicals of the formulae —(CH₂)₃—NH—(CH₂)₃—, —(CH₂)₃—NR⁵—(CH₂)₃—, —(CH₂)₃—(CH₂—CH₂O)_{f}—(CH₂)₃— —O— (CH₂—CH₂O)_{f}—

An example of A² is N[(CH₂)₃—]₃.

Organosilicon compounds (A) may also be formed from crude products during the process.

Preferred examples of organosilicon compounds (A) are linear trimethylsilyl- or hydroxydimethylsilyl-terminated polydimethylsiloxanes, such as, for example, oils having a viscosity of 50 mPa·s, comprising

96.5 mol % of (CH₃)₂SiO_{2/2} and 3.5 mol % of (CH₃)₃SiO_{1/2} or 96.5 mol % of (CH₃)₂SiO_{2/2} and 3.5 mol % of (CH₃)₂(OH)SiO_{1/2};

oils having a viscosity of 100 mPa·s, comprising 98 mol % of (CH₃)₂SiO_{2/2} and 2 mol % of (CH₃)₃SiO_{1/2} or 98 mol % of (CH₃)₂SiO_{2/2} and 2 mol % of (CH₃)₂(OH)SiO_{1/2};

oils having a viscosity of 1000 mPa·s, comprising 99.2 mol % of (CH₃)₂SiO_{2/2} and 0.8 mol % of (CH₃)₃SiO_{1/2} or 99.2 mol % of (CH₃)₂SiO_{2/2} and 0.8 mol % of (CH₃)₂(OH) SiO_{1/2};

oils having a viscosity of 12 500 mPa·s, comprising 99.63 mol % of (CH₃)₂SiO_{2/2} and 0.37 mol % of (CH₃)₃SiO_{1/2} or

99.63 mol % of (CH₃)₂SiO_{2/2} and 0.37 mol % of (CH₃)₂(OH) SiO_{1/2};

Oils having a viscosity of 100 000 mPa·s, comprising 99.81 mol % of (CH₃)₂SiO_{2/2} and 0.19 mol % of (CH₃)₃SiO_{1/2} or

99.81 mol % of (CH₃)₂SiO_{2/2} and 0.19 mol % of (CH₃)₂(OH) SiO_{1/2}.

Preferred examples of resin-like organosilicon compounds (A) are methylethoxy resins, for example of the formula CH₃Si(OC₂H₅)_{0.8}(O)_{1.1}; methyl resins, for example comprising 80 mol % of CH₃SiO_{3/2} and 20 mol % of (CH₃)₂SiO_{2/2} and having a molar mass of about 5000 g/mol or 98 mol % of CH₃SiO_{3/2} and 2 mol % of (CH₃)₂SiO_{2/2} and having a molar mass of about 5000 g/mol.

If the organosilicon compound (A) itself acts as an emulsifier, organosilicon compound (A) and emulsifier (B) can be identical. It is then possible to dispense with the addition of separate emulsifier (B).

The constituent (B) of the emulsion preferably comprises commercially available and thoroughly investigated emulsifiers, such as, for example, sorbitan esters of fatty acids having 10 to 22 carbon atoms; polyoxyethylene sorbitan esters of fatty acids having 10 to 22 carbon atoms and an ethylene oxide content of up to 35 percent; polyoxyethylene sorbitan esters of fatty acids having 10 to 22 carbon atoms; polyoxyethylene derivatives of phenols having 6 to 20 carbon atoms on the aromatic and an ethylene oxide content of up to 95 percent; fatty amino- and amidobetaines having 10 to 22 carbon atoms; polyoxyethylene condensates of fatty acids or fatty alcohols having 8 to 22 carbon atoms with an ethylene oxide content of up to 95 percent; ionic emulsifiers, such as alkylaryl sulfonates having 6 to 20 carbon atoms in the alkyl group; fatty acid soaps having 8 to 22 carbon atoms; fatty sulfates having 8 to 22 carbon atoms; alkanesulfonates having 10 to 22 carbon atoms; alkali metal salts of dialkylsulfosuccinates; fatty amine oxides having 10 to 22 carbon atoms; fatty imidazolines having 6 to 20 carbon atoms; fatty amidosulfobetaines having 10 to 22 carbon atoms; quarternary emulsifiers, such as fatty ammonium compounds having 10 to 22 carbon atoms; fatty morpholine oxides having 10 to 22 carbon atoms; alkali metal salts of carboxylated, ethoxylated alcohols having 10 to 22 carbon atoms and up to 95 percent of ethylene oxide; ethylene oxide condensates of fatty acid monoesters of glycerol having 10 to 22 carbon atoms and up to 95 percent of ethylene oxide; mono- and diethanolamides of fatty acids having 10 to 22 carbon atoms; phosphate esters; organosilicon compounds (A) which have units of the general formula I, in which X is a radical of the general formula II and c is at least 1.

It is well known in the area of emulsifiers, the opposition ions in the case of anionic emulsifiers can be alkali metals, ammonia or substituted amines, such as trimethylamine or triethanolamine. Usually, ammonium, sodium and potassium ions are preferred. In the case of cationic emulsifiers, the opposition ion is a halide, sulfate or methylsulfate. Chlorides are the most industrially available compounds.

The abovementioned fatty structures are usually the lipophilic half of the emulsifiers. A customary fatty group is an alkyl group of natural or synthetic origin. Known unsaturated groups are the oleyl, linoleyl, decenyl, hexadecenyl and dodecenyl radicals. Alkyl groups may be cyclic, linear or branched. Other possible emulsifiers are sorbitol monolaurate/ethylene oxide condensates; sorbitol monomyristate/ethylene oxide condensates; sorbitol monostearate/ethylene oxide condensates; dodecylphenol/ethylene oxide condensates; myristylphenol/ethylene oxide condensates; octylphenyl/ethylene oxide condensates; stearylphenol ethylene oxide condensates; lauryl alcohol/ethylene oxide condensates; stearyl alcohol/ethylene oxide condensates; decylaminobetaine; cocoamidosulfobetaine; olylamidobetaine; cocoimidazoline; cocosulfoimidazoline; cetylimidazoline; 1-hydroxyethyl-2-heptadecenylimidazoline; n-cocomorpholine oxide; decyldimethylamine oxide; cocoamidodimethylamine oxide; sorbitan tristearate having condensed ethylene oxide groups; sorbitan trioleate having condensed ethylene oxide groups; sodium or potassium dodecyl sulfate; sodium or potassium stearyl sulfate; sodium or potassium dodecylbenzenesulfonate; sodium or potassium stearylsulfonate; triethanolamine salt of dodecylsulfate; trimethyldodecylammonium chloride; trimethylstearylammonium methosulfate; sodium laurate; sodium or potassium myristate.

It is known that it is also possible to use inorganic solids as emulsifiers (B). These are, for example, silicas or bentonites, as described in EP 1017745 A or DE 19742759 A.

The non-ionic emulsifiers are preferred. The constituent (B) may consist of an above-mentioned emulsifier or of a mixture of two or more abovementioned emulsifiers and can be used in pure form or as solutions of one or more emulsifiers in water or organic solvents.

Emulsifiers (B) are used in amounts of, preferably, from 0.1 to 60% by weight, particularly preferably from 1 to 30% by weight, based in each case on the total weight of organosilicon compounds (A).

Between the second and third rotor-stator mixer and after the third mixer further additives (Z), such as silanes, acids, alkalis, biocides, thickeners, silicas and water-soluble polysiloxanes, can be added in addition to water and emulsifiers.

Examples of silanes are vinyltris(methoxyethoxy)silane, tetraethoxysilane, anhydrolyzed tetraethoxysilane, methyltriethoxysilane, anhydrolyzed methyltriethoxysilane, aminoethylaminopropyltrimethoxysilane, aminoethylaminopropyl(methyl)dimethoxysilane.

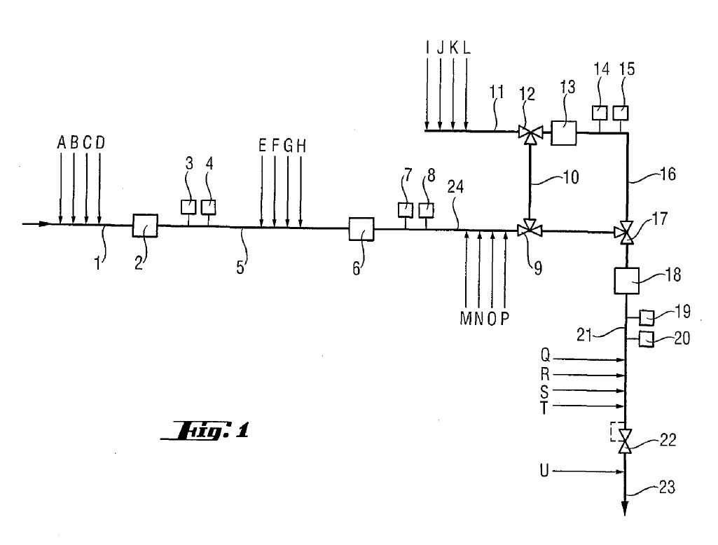

The process is explained by way of example with reference to FIG. 1. At least one emulsifier (B) or a solution of an emulsifier (B) and optionally water (C), optionally one or more organosilicon compounds (A) and additives (Z) are metered continuously through the feed pipes A, B, C and D into the feed pipe 1. A static mixing element can optionally be installed in the feed pipe 1 for improving the mixing of the components before the first high-shear mixer 2. After the first mixer 2, a stiff phase is produced. After the mixer 2, a temperature sensor 3 and a pressure sensor 4 are installed in the pipe 5. The specified temperature and the specified pressure in the pipe 5 are fixed by the pressure control valve 22 and the speed of the high-shear mixer 2. The temperature is regulated by the temperature of the raw materials, which are thermostatted according to specifications, and by the speed of the mixer. One or more emulsifiers (B), one or more organosilicon compounds (A), water (C) and additives (Z) can be introduced, once again continuously, into the feed pipe 5. The mixture or solid phase can also be transferred without metering into the second high-shear mixer 6. The temperature after mixer 6 is measured by the temperature sensor 7 and regulated by means of the temperature of the raw materials and the speed of the mixer 6. The pressure after mixer 6 is measured by the pressure sensor 8 and regulated by means of the pressure control valve 22 and the speed of the mixer 6. After the mixer 6, one or more emulsifiers (B), one or more organosilicon compounds (A), water (C) and additives (Z) can once again be metered. Thereafter, the product in pipe 24 can be passed via an optionally present valve 9 and an optionally present pipe 10 to the mixer 13 or fed further in pipe 24 via an optionally present valve 17 to the high-shear mixer 18. Here too, raw materials can be metered before mixer 13. The temperatures and the pressures after mixer 13 and mixer 18 are measured as described above by the temperature regulators 14 and 19 and the pressure sensors 15 and 20 and regulated as described above. If the path of a product via pipe 10 is not used, pre-mixes or pre-emulsions can be prepared in the mixer 13 in the manner described and can be fed to the product before mixer 18. The temperature and pressure regulation takes place analogously. After mixer 18, further emulsifiers (B), organosilicon compounds (A), water (C) and additives (Z) can be added. Furthermore, it is possible to dilute the emulsion further with water after the pressure control valve 22 before the final product is filled into a tank or a sales container.

All above symbols of the above formulae have their meanings in each case independently of one another. In all formulae, the silicon atom is tetravalent.

In the following examples, all quantity and percentage data are based on weight, unless stated otherwise, all temperatures are 20° C. and all pressures are 1.013 bar (abs.). All viscosities are determined at 25° C.

### EXAMPLES

### Example 1

### Preparation of a Clear Emulsion of an Aminofunctional Polysiloxane

16.25% of aminofunctional silicone oil (Wacker® Finish WR 1300) at a temperature of 40° C. (the temperature is regulated to ±2 K), 1.60% of isotridecyl alcohol ethoxylate having on average 8 EO (Arlypon® IT 8), 4.14% of isotridecyl alcohol ethoxylate having on average 5 EO (Lutensol® TO 5), 0.2% of acetic acid (80% strength) and 3.93% of demineralized water (temperature 12° C., the temperature is regulated to ±2 K) are fed to the mixer 2 (4000 rpm). The pressure control valve 22 is set at 4.5 bar. 3.6% of demineralized water (12° C., the temperature is regulated to ±2 K) are metered to the mixer 6 (3000 rpm). Mixer 13 is not used, and the product is fed to the mixer 18 after mixer 6. After mixer 6, 66.9% of demineralized water (12° C.) and 0.08% of preservative (Kathon® LXE) are added and the mixture is fed to mixer 18 (3000 rpm). After mixer 18, 3.5% of glycerol are metered.

The chosen temperatures and process parameters result in a pressure of 3 bar and a temperature of 43.5° C. after mixer 2, a pressure of 3.1 bar and a temperature of 50° C. after mixer 6 and a pressure of 4.5 bar and a temperature of 23° C. after mixer 18. These process parameters are monitored, documented and controlled by means of a process control system and lead to a clear silicone emulsion having a particle size of 20 nm and a turbidity of 10 ppm. The emulsion remains stable for several months at a storage temperature of 50° C.

### Comparative Example 1b

If the analogous process conditions as stated under example 1 are chosen but the process is not carried out according to the invention but the aminofunctional silicone oil is metered at room temperature (20° C.) this leads to a substantial temperature drop at the mixer 2 (20° C.) and mixer 6 (25° C.), but the pressure remains substantially unchanged.

The product prepared has a substantially larger particle size of 42 nm and a turbidity of 23 ppm. On storage at 50° C., phase separation is found after 3 weeks.

### Example 2

### Preparation of a Polyvinyl Alcohol-Stabilized Silicone Resin Emulsion

35.3% of polyvinyl alcohol solution (10% strength) (25° C., the temperature is kept constant at ±2 K) and 48.4% of a mixture of silicone resin (80 mol % of T units, 20 mol % of D units, 20° C.) with an OH-terminated polydimethylsiloxane having a viscosity of 30 mPa·s and 4.7% of demineralized water (12° C.) are metered to the mixer 2 (4000 rpm). This mixture is fed to the mixer 6 and again subjected to shearing in the mixer 6 (3000 rpm). After the mixer 6, 11.36% of demineralized water (12° C.) and 0.24% of preservative (Rocima® 523) are added and the mixture is fed to the mixer 18 (3000 rpm). The pressure control valve 22 is set at 2 bar. These process parameters lead to a pressure of 2 bar and a temperature of 33° C. after mixer 2, 2 bar and 35° C. are likewise measured after mixer 6 and 2 bar and 36° C. are recorded after mixer 18. With the specified process parameters, an emulsion which has a storage stability of 1 year at room temperature without phase separation is produced.

### Comparative Example 2b

If the above process parameters are otherwise unchanged and only the temperature of the polyvinyl alcohol solution is not monitored and is not increased according to the invention to 50° C. the temperature after mixer 2 increases to about 45° C. and accordingly the temperature after mixers 6 and 22 increases to 46° C. The product obtained shows substantial deposition of silicone resin after storage for only 2 weeks at room temperature.

### Example 3

### Polycondensation in Emulsion

34.88% of an OH-functional polydimethylsiloxane (15° C.) having a viscosity of about 30 mPa·s and 3.7% of an isotridecyl alcohol ethoxylate having 10 EO units (80% strength solution in water) and 4.5% of demineralized water and 3% of dodecylbenzenesulfonic acid are fed to the mixer 2 (4000 rpm). This mixture is fed to the mixer 6 (3000 rpm) and is worked through again there. The mixture is fed to mixer 18, and 40.43% of demineralized water and 0.08% of preservative (Kathon® LXE) are metered before the mixer 18 (3000 rpm).

The pressure control valve 22 is set at 3 bar.

This mixture is then stored in a container for an average residence time of 7.5 hours. An acid-catalyzed condensation of the polydimethylsiloxane takes place there.

After 7.5 hours, 2.1% of triethanolamine (80% strength) and 11.27% of demineralized water are added. The acid is thus neutralized and the reaction stops.

In the process carried out according to the invention 3 bar and 26° C. are measured after mixer 2.2 bar and 37° C. are reached after mixer 6 and 27° C. after mixer 18. This leads to a finely divided silicone emulsion (150 nm) having an oil viscosity of 100 000 mPa·s. The storage stability of the emulsion is more than 2 years.

### Comparative Example 3b

If, in the process not according to the invention, all parameters are left unchanged and the temperature of the polydimethylsiloxane is kept at 25° C., the result is an emulsion which has a comparative particle size (154 nm) but only an oil viscosity of 60 000 mPa·s, which is too low.

1-4. (canceled)

5. A process for the continuous preparation of aqueous emulsions comprising organosilicon compound(s) (A), emulsifier(s) (B) and water (C), comprising
a) feeding at least a portion of the (A), (B), and (C) components continuously to a first high-shear mixer in which a highly viscous silicone emulsion is formed;
b) feeding the highly viscous silicone emulsion from a) to a second high-shear mixer, and optionally admixing further components (A), (B), and (C);
c) establishing a set point for each of temperature and pressure for emulsion exiting the first high shear mixture and the second shear mixer, measuring the temperatures and pressure of the emulsion exiting the first high shear mixer and the second high speed mixer, and adjusting process parameters to maintain the temperature and pressures of the emulsion exiting the first and second high speed mixers at their respective set points.

6. The process of claim 5, wherein the pressure measured after said first or after said second high shear mixer is adjusted by regulating the pressure after the second high-shear mixer.

7. The process of claim 5, wherein the pressure measured after a high speed mixer is adjusted by regulating the speed of the high speed mixer.

8. The process of claim 6, wherein the pressure measured after a high speed mixer is adjusted by regulating the speed of the high speed mixer.

9. The process of claim 5, the temperature is regulated by adjusting the temperature of the raw materials and the speed of the mixers.

10. The process of claim 6, the temperature is regulated by adjusting the temperature of the raw materials and the speed of the mixers.

11. The process of claim 7, the temperature is regulated by adjusting the temperature of the raw materials and the speed of the mixers.

12. The process of claim 5, wherein the organosilicon compound (A) is liquid at 25° C. and has a viscosity of from 0.5 to 500,000 mPa·s.
